(19) United States
(12) Patent Application Publication
(10) Pub. No.: US 2007/0000969 A1
(43) Pub. Date: Jan. 4, 2007

(54) Brazed aluminum structure and method for forming same

(76) Inventors: Kurt Ross Mittlefehldt, Amherst, NY (US); Mingguang Zhu, E. Amherst, NY (US)

Correspondence Address: DELPHI TECHNOLOGIES, INC., M/C 480-410-202, PO BOX 5052, TROY, MI, 48007, US

(21) Appl. No.: 11/471,021

(22) Filed: Jun. 20, 2006

Related U.S. Application Data
(60) Provisional application No. 60/692,307, filed on Jun. 20, 2005.

(51) Int. Cl. A47J 36/02

(52) U.S. Cl. 228/101

(57) ABSTRACT

A brazed aluminum alloy structure is formed that includes a first component formed of an aluminum alloy sheet, a second metal sheet component formed of an aluminum alloy and a braze fillet metallurgically bonding a faying surface of the first component to a faying surface of the second component. The braze fillet is composed of a hypoeutectic aluminum silicon alloy comprising between 0.005 and 0.045 weight percent strontium. The strontium addition produces a microstructure characterized by coral-like silicon particles that improve corrosion resistance.

### CROSS REFERENCE TO RELATED APPLICATION

This application claims the benefit of U.S. Provisional Application No. 60/692,307, filed Jun. 20, 2005, which is incorporated herein by reference.

### TECHNICAL FIELD OF INVENTION

This invention relates to method for brazing aluminum sheet components, and more particularly, to such method wherein the braze fillet is formed of an aluminum silicon alloy containing strontium to improve corrosion resistance.

### BACKGROUND OF INVENTION

A common heat exchanger is manufactured of components, such as tubes, fins and header tanks, formed of braze clad aluminum sheet. The sheet comprises a core of aluminum alloy coated with a cladding of a braze alloy. A typical braze alloy is composed of hypoeutectic aluminum and silicon alloy. The components are arranged in an assembly, and the assembly is heated to a temperature sufficient to melt the braze alloy, whereupon the molten alloy is drawn by capillary forces into regions between the components. Upon cooling, the braze alloy solidifies to form a fillet metallurgically bonded to the components, thereby joining the components into an integral structure.

In acidic or pitting corrosion of the type that occurs in automotive environments, attack of the braze alloy can produce a corrosion path in the fillet through which fluid or gas may leak from the heat exchanger. With advances in higher corrosion resistant aluminum alloys that form the metal sheet, corrosion tends to preferentially attack the fillet at a faster rate than the sheet, so that leakage through the braze fillet is a significant area of concern for manufacturers of heat exchangers.

It has been proposed to add strontium to aluminum alloys to improve mechanical properties. In general, strontium additions greater than 0.1 percent have been reported to increase strength and ductility. However, it is believed that strontium also increases fluidity, which reduces the ability of the molten alloy to be drawn by capillary forces into the gap between faying surfaces within the short cycle time typical of commercial brazing processes. As a result, the braze alloy may not accumulate within the gap in sufficient quantity to form a fillet of suitable size to produce a strong bond between the faying surfaces.

Thus, there is a need for a braze joint formed between aluminum sheet components that has improved corrosion resistance, which may be formed without adversely affecting the flow of braze alloy during the brazing process to form the desired fillet.

### SUMMARY OF THE INVENTION

In accordance with a preferred embodiment of this invention, a method for brazing aluminum alloy sheet components is carried out using a first component formed of an aluminum alloy sheet and having a braze cladding applied to a surface of the aluminum alloy sheet. The braze cladding is composed of a hypoeutectic aluminum silicon alloy comprising between 0.005 and 0.045 weight percent strontium. The first component is arranged with a second component such that the braze cladding is interposed between a first faying surface of the first component and a second faying surface of the second component. The arrangement is heated to a temperature effective to melt the braze alloy to form a liquid phase and thereafter cooled to solidify the liquid phase to form a braze fillet bonding the first faying surface and the second faying surface.

In another aspect of this invention, a brazed aluminum alloy structure is formed that includes a first component formed of an aluminum alloy sheet, a second metal sheet component formed of an aluminum alloy and a braze fillet metallurgically bonding a faying surface of the first component to a faying surface of the second component. The braze fillet is formed of a hypoeutectic aluminum silicon alloy comprising between 0.005 and 0.045 weight percent strontium.

In a particular embodiment, this invention provides a heat exchanger formed of first and second sheet metal components of an aluminum alloy and having a braze joint metallurgically bonded to a faying surface of the first component and a faying surface of the second component, in which the braze joint is formed of a hypoeutectic braze alloy composed of between 6.0 and 13.0 weight percent silicon, 0.015 and 0.035 weight percent strontium, and the balance predominantly aluminum. The braze joint is characterized by a microstructure comprising a eutectic phase containing coral-like silicon effective to improve corrosion resistance.

In still another aspect of this invention, a braze clad aluminum sheet is provided that comprises a sheet formed of an aluminum alloy and a braze cladding on a first surface of the sheet, which braze cladding is composed of a hypoeutectic aluminum silicon alloy comprising between 0.005 and 0.045 weight percent strontium.

### BRIEF DESCRIPTION OF DRAWINGS

This invention will be further described with reference to the accompanying drawings in which:

FIG. 1 is cross-sectional view of portion of an arrangement in preparation for brazing in accordance with this invention; and

FIG. 2 is a cross-sectional view of the arrangement in FIG. 1 following brazing.

### DETAILED DESCRIPTION OF INVENTION

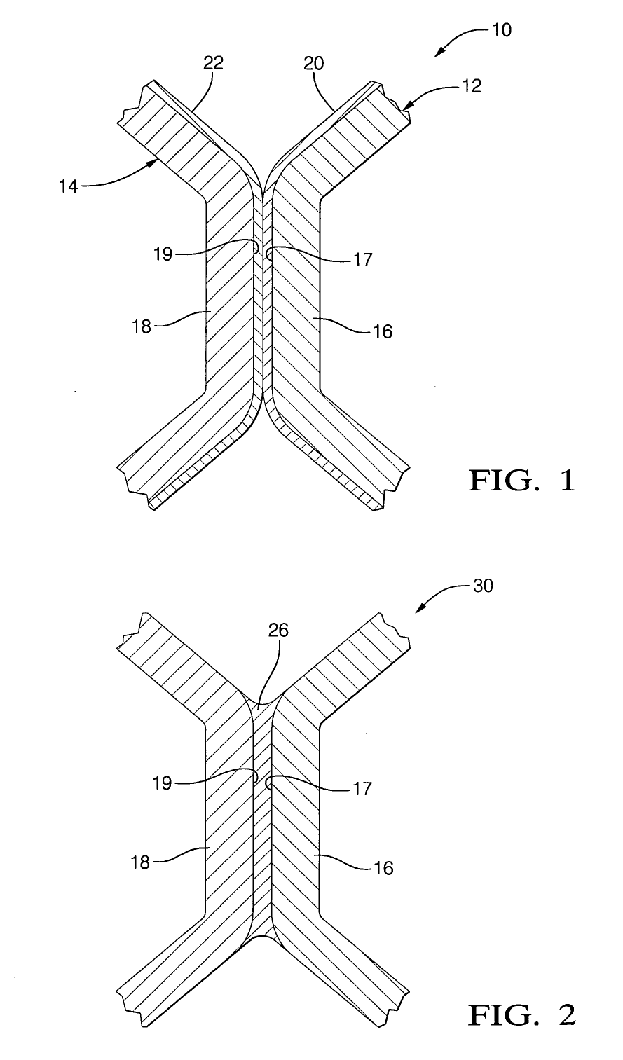

In accordance with a preferred embodiment of this invention, referring to FIGS. 1, there is depicted a portion of a pre-braze assembly 10 for manufacturing an automotive heat exchanger. Assembly 10 comprises a first clad sheet metal component 12 and a second clad sheet metal component 14. As used herein, sheet metal component refers to a component that comprises a base having a thin cross section, and is preferably a metal sheet formed by a stamping operation or the like. Components 12 and 14 comprise a first and second sheet 16 and 18, respectively, also referred to as a core or base, composed of an aluminum alloy suited for manufacture of a heat exchanger. A preferred alloy is an aluminum manganese alloy and is selected from the group designated series AA 3000 by the Aluminum Association. The preferred alloy contains manganese sufficient to provide corrosion resistance. In addition, the core alloy may contain up to 1.5 weight percent zinc or up to 0.35 weight percent titanium to further enhance corrosion resistance. In general, the particular alloy for the sheet elements is chosen based upon the specific product and the application environment.

Sheets 16 and 18 include first and second faying surfaces 17 and 19 at the region where a braze joint is desired. Claddings 20 and 22, respectively, are applied to the surfaces of sheets that include faying surfaces 17 and 19. Claddings 20 and 22 are formed of an aluminum-silicon braze alloy having a melting temperature less than the core alloy. A suitable braze alloy is composed of a hypoeutectic aluminum-silicon alloy and contains silicon in an amount less than about 13.0 weight percent, preferably between 6.0 and 12.5 weight percent. In accordance with this invention, the braze alloy contains strontium in an amount between about 0.005 and 0.045 weight percent, and preferably between about 0.015 and 0.035 weight percent. In brazing operations where interaction between flux and strontium is minimized, the preferred range is up to 0.025 weight percent.

By way of a preferred example, a braze alloy in accordance with this invention is formed by an addition of strontium to a base alloy having a composition corresponding to AA 4145. Braze alloy AA 4145 is particularly formulated for a controlled atmosphere brazing process and comprises, by weight, about 9.3 and 10.7 percent silicon, up to about 0.8 percent iron, 3.3 to 4.7 percent copper, up to about 0.15 percent manganese, up to about 0.15 percent magnesium, up to about 0.20 percent zinc, and up to about 0.15 percent chromium, with the balance of at least 83 percent aluminum. Alternately, strontium may be added to enhance corrosion resistance of braze alloy AA 4147 that is formulated for a vacuum brazing process.

Cladding may be applied to the sheet by any suitable process. A preferred commercial process is roll bonding in which the core alloy and the braze alloy are concurrently passed through rollers to form a dual-layer sheet stock. In an alternate example, the cladding may be applied by a kinetic spray process in which braze alloy powder is applied to the surface of the core sheet.

To manufacture a brazed product, sheet metal components are formed and arranged as shown in FIG. 1. In the arrangement, claddings 20 and 22 are interposed between sheets 16 and 18, with the claddings being in contact within the gap between first and second faying surfaces 17 and 19 at the region where a braze joint is desired. The arrangement is heated to a temperature sufficient to melt the braze alloy of claddings 20 and 22, but not sufficient to melt the core alloy that forms the metal sheets. In a preferred controlled atmosphere brazing (CAB) process wherein the cladding is formed of strontium-modified AA 4145 braze alloy, potassium aluminum fluoride flux is applied to the surface of the cladding prior to heating, and the arrangement is heated in a nitrogen atmosphere, to inhibit oxidation of the braze alloy during melting. Alternately, brazing may be suitably carried out in a vacuum, without requiring flux. The assembly is heated to a temperature above the melting point of the aluminum-silicon eutectic, which is about 521° C. It is noted that the a suitable braze liquid may be formed without exceeding the liquidus temperature at which the alloy is completely melted, which is about 585° C. for AA 4145 braze alloy.

Upon melting, the molten braze alloy wets the underlying faying surfaces 17 and 19 of the aluminum sheets and is drawn by capillary forces into the gap between the metal sheets. Upon cooling, the molten alloy solidifies to form a fillet 26 that is metallurgically bonded to the adjacent faying surfaces, thereby forming brazed structure 28 in FIG. 2.

In a preferred embodiment, product brazed structure is a heat exchanger of the type employed in an automotive heating and air conditioning system.

While not limited to any particular theory, it is believed that, when exposed to an acidic corrosive environment, oxidation of aluminum occurs preferential to silicon. As a result, the propagation of oxidation through the braze fillet is through aluminum and is blocked by silicon formations. More particularly, solidification of hypoeutectic alloy produces a microstructure comprising alpha phase composed of aluminum particles dispersed in a eutectic phase, which eutectic phase comprises silicon particles in an aluminum matrix. In the absence of strontium, the silicon tends to form needle-like particles that are spaced apart so as to provide a ready path for oxidation propagation through the aluminum. The addition of strontium in accordance with this invention produces a refined microstructure that is characterized by coral-like silicon in the eutectic phase. This coral-like silicon forms a maze that is more effective in blocking oxidation through the alloy. As a result, corrosion of the fillet is retarded.

It is significant that the formation of the corrosion-resistant coral-like silicon microstructure is accomplished with a minimal strontium addition of less than 0.045 weight percent. The low strontium addition is believed to have a minimal affect upon surface tension and fluidity. As a result, the fluidity is suitable to draw the molten alloy into the gap in a sufficient amount to assure formation of a fillet of proper size and density to form a strong and leak-free joint. Thus, this invention improves the corrosion resistance of the joint without adversely affecting the brazing process or fillet formation.

While this invention has been described in terms of the preferred embodiments thereof, it is not intended to be so limited, but rather only to the extent set forth in the claims that follow.

We claim:

1. A method for brazing aluminum alloy sheet components, said method comprising
providing a first component formed of an aluminum alloy sheet having a first faying surface;
providing a braze cladding on said first faying surface, said braze cladding being composed of a hypoeutectic aluminum silicon alloy comprising between 0.005 and 0.045 weight percent strontium;
arranging a second component with said first component to form an arrangement, said second component being formed of an aluminum alloy and having a second faying surface, said arrangement comprising a region whereat said braze cladding is interposed between said first faying surface and said second faying surface;
heating the arrangement to a temperature effective to melt the braze alloy to form a liquid phase at said region; and
cooling the arrangement to solidify the liquid phase to form a braze fillet bonding the first faying surface and the second faying surface.

2. A method in accordance with claim 1 wherein the braze alloy contains strontium in an amount between 0.015 and 0.035 weight percent.

3. A brazed structure in accordance with claim 1 wherein the braze alloy is composed of between 6.0 and 12.5 weight percent silicon, 0.015 and 0.035 weight percent strontium, and the balance predominantly aluminum.

4. A method in accordance with claim 1 wherein the braze alloy further comprises about 3.3 to 4.7 weight percent copper.

5. A method in accordance with claim 1 wherein said strontium is effective to form a braze fillet having microstructure characterized by a eutectic phase containing coral-like silicon.

6. A method in accordance with claim 1 wherein the second component includes a braze cladding composed of a hypoeutectic aluminum silicon alloy comprising between 0.005 and 0.045 weight percent strontium, and wherein the first component and the second component are arranged such that the braze cladding of the first component is in contact with the braze cladding of the second component.

7. A method in accordance with claim 1 further comprising applying a flux composed of a potassium aluminum fluoride compound to said braze cladding prior to heating to melt the braze alloy.

8. A brazed aluminum alloy structure comprising
a first component formed of an aluminum alloy sheet and having a faying surface;
a second metal sheet component formed of an aluminum alloy and comprising a second faying surface;
a braze fillet metallurgically bonded to the first faying surface and the second faying surface and formed of a hypoeutectic aluminum silicon alloy comprising between 0.005 and 0.045 weight percent strontium.

9. A brazed structure in accordance with claim 8 wherein the braze alloy contains strontium in an amount between 0.015 and 0.035 weight percent.

10. A brazed structure in accordance with claim 8 wherein the hypoeutectic aluminum silicon alloy contains between about 6.0 and 12.5 weight percent silicon, between 0.015 and 0.035 weight percent strontium, and the balance predominantly aluminum.

11. A brazed structure in accordance with claim 8 wherein said braze fillet is characterized by a microstructure comprising a eutectic phase containing coral-like silicon

12. A heat exchanger comprising
a first sheet metal component formed of an aluminum alloy and having a first faying surface;
a second sheet metal component formed of an aluminum alloy and comprising a second faying surface; and
a braze joint metallurgically bonded to the first faying surface and the second faying surface, said braze joint being formed of a hypoeutectic braze alloy composed of between 6.0 and 12.5 weight percent silicon, 0.015 and 0.035 weight percent strontium, and the balance predominantly aluminum and characterized by a microstructure comprising a eutectic phase containing coral-like silicon.

13. A braze clad aluminum sheet comprising
a sheet formed of an aluminum alloy and having a first surface; and
a braze cladding on said first surface and composed of a hypoeutectic aluminum silicon alloy comprising between 0.005 and 0.045 weight percent strontium.

14. A braze clad aluminum sheet in accordance with claim 13 wherein the braze cladding is composed of between 6.0 and 12.5 weight percent silicon, 0.015 and 0.035 weight percent strontium, and the balance predominantly aluminum.

15. A braze clad aluminum sheet in accordance with claim 13 wherein the sheet comprises a second surface opposite the first surface and wherein the component comprises a braze cladding on said second surface and composed of a hypoeutectic aluminum silicon alloy comprising between 0.005 and 0.045 weight percent strontium.
